(19) United States
(12) Patent Application Publication
(10) Pub. No.: US 2004/0141092 A1
(43) Pub. Date: Jul. 22, 2004

(54) Image display apparatus and scanning line converting and displaying method

(75) Inventor: Shigeki Kamimura, Tsurugashima-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/717,928

(22) Filed: Nov. 21, 2003

(30) Foreign Application Priority Data
Nov. 22, 2002 (JP) 2002-339434

(51) Int. Cl. H04N 11/20

(52) U.S. Cl. 348/458; 348/792

(57) ABSTRACT

First and second line memories alternately store input video signals for every scanning line. The video signals stored in the line memories are read by a predetermined number of times in accordance with a signal system of the input video signals. A calculator calculates average values among the video signals read from the line memories. A selector circuit sequentially selects the video signals read from the first and second line memories when the input video signals are based on an interlace system, and sequentially selects the video signals read from the first and second line memories and the averaged video signals when the input video signals are based on a progressive scan system. The selected signals are supplied to a liquid crystal display apparatus.

### CROSS-REFERENCE TO RELATED APPLICATIONS

This application is based upon and claims the benefit of priority from the prior Japanese Patent Application No. 2002-339434, filed Nov. 22, 2002, the entire contents of which are incorporated herein by reference.

### BACKGROUND OF THE INVENTION

1. Field of the Invention

This invention relates to a technology for displaying interlaced video signals on a progressive scanning display device, and more particularly to an image display apparatus which uses a liquid crystal or plasma of an afterimage effect.

2. Description of the Related Art

In the case of an NTSC video signal generally used as a television broadcast wave, a video is scanned by interlacing to increase the number of equivalent images per sec., and to reduce surface flickers. Jpn. Pat. Appln. KOKOKU Publication No. 3-20115 discloses a method which converts an interlaced signal into a signal of an noninterlace double scan system and displays it on a television receiver. This method rectifies roughness of the interlaced video to a certain extent.

On the other hand, a thin television receiver such as a liquid crystal display apparatus or a plasma display apparatus has started to gain in popularity in recent years. If such a display apparatus is used to directly display the interlaced video signal on each scanning line, screen luminance is considerably lowered to make the video unworthy of appreciation. Thus, in such a display apparatus, the video is displayed by a progressive scanning (noninterlace) system.

The displaying of the interlaced signal on the progressive scanning display device such as a liquid crystal display apparatus has necessitated an interlace/progressive conversion circuit. The interlace/progressive conversion circuit comprises at least two field memories for storing fields of the video signal, a moving image detection circuit for detecting a movement of an object displayed on the screen, and a scanning line synthesis circuit. The scanning line synthesis circuit carries out a process of dividing an image into a static image portion and a moving image portion based on a detection result of the moving image detection circuit, synthesizes images of odd and even fields on the static image portion, and creates new scanning lines from a video signal in a field on the moving image portion. Thus, a progressive scanning signal is outputted from the scanning line synthesis circuit, and the progressive scanning line signal is displayed on the progressive scanning display device.

Thus, interlace/progressive (IP) conversion for extracting the static image and moving image portions to form the progressive scanning video by interlacing enables displaying of the video by a high quality. However, such a conversion circuit needs at least two frame memories and a moving image detection circuit, and a circuit size becomes relatively large even in the case of a normal NTSC signal. When the IP conversion circuit is applied to a progressive display apparatus which has 1080 effective scanning lines, a circuit size is further enlarged to require high-speed processing, which causes a great increase in cost.

### BRIEF SUMMARY OF THE INVENTION

An image display apparatus according to an embodiment of the present invention comprises: first and second line memories which alternately store input video signals for every scanning line; a reading section which reads the video signals stored in the first and second line memories at a predetermined speed; a calculation section which calculates new video signals from the video signals read from the first and second line memories by the reading section; a selection section which selectively outputs video signals of one scanning line among the video signals read from the first and second line memories and the new video signals calculated by the calculation section; a video output control section which controls the selection section to select and output the video signals read from the first and second line memories when the input video signals are based on an interlace system, and to select and output the signals read from the first and second line memories and the new video signals calculated by the calculation section when the input video signals are based on a progressive scan system; a display section which displays a video corresponding to the video signals selected by the selection section in accordance with the progressive scan system; and a display control section which controls the display section so that odd and even fields of the video signals selected by the selection section can be displayed by being deviated from each other by a predetermined number of scanning lines.

### BRIEF DESCRIPTION OF THE SEVERAL VIEWS OF THE DRAWING

FIG. 1 is a block diagram showing a constitutional example of a television receiver 11 as an image display apparatus of the present invention.

FIG. 2 is a block diagram showing a constitution of a video signal switching section 16a according to a first embodiment of the present invention.

FIGS. 3A to 3D are timing charts showing an operation of the video signal switching section 16a when an input signal system is interlacing.

FIGS. 4A and 4B are views showing a display sequence of video data in an odd (ODD) field and an even (EVN) field.

FIGS. 5A to 5D are timing charts showing an operation of the video signal switching section 16a when an input signal system is progressive scanning.

FIG. 6 is a view showing a constitution of a liquid crystal display apparatus as an image display apparatus 17.

FIG. 7 is a view showing a constitutional example of a signal line driving circuit 1.

FIG. 8 is a block diagram showing a constitution of a video signal switching section 16b according to a second embodiment.

### DETAILED DESCRIPTION OF THE INVENTION

The embodiments of the present invention will now be described in detail with reference to the accompanying drawings.

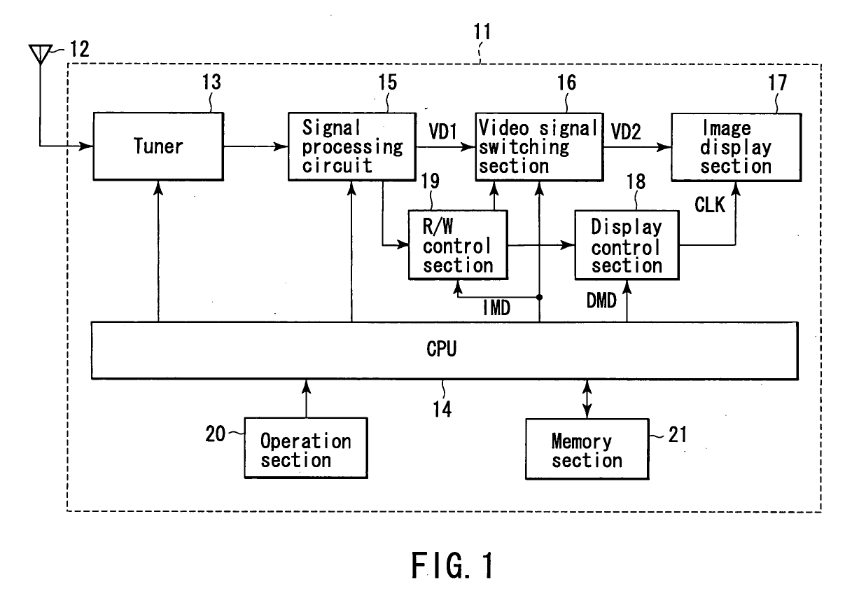

FIG. 1 is a block diagram showing a constitutional example of a television receiver 11 to which the present invention is applied. A broadcast wave received by an antenna 12 is supplied to a tuner 13, and a broadcast channel specified by a user is selected under control of a CPU 14. A signal outputted from the tuner 13 is demodulated by a signal processing circuit 15, and converted into video data VD1.

A video signal switching section 16 generates video data VD2 of scanning lines suited to an image display section 17 from video data outputted from the signal processing circuit 15. A read/write (RW) control section 19 generates a reading or writing signal in accordance with a system discrimination signal IMD supplied from the CPU 14, and supplies it to the video signal switching section 16. This system discrimination signal IMD indicates that a broadcast wave of the channel selected by the tuner 13 is based on an interlace system, e.g., 480i or 1080i, or a progressing scan system, e.g., 480p or 720p. A numeral such as 480 denotes the number of effective scanning lines, “i” denotes interlace scan, and “p” denotes progressive scan.

The video data VD2 is supplied to the image display section 17, and a program of a desired channel is displayed by the image display section 17. At this time, a display control section 18 generates various display clock signals CLK for the image display section 17 in accordance with a display mode signal DMD. According to the embodiment, the image display section 17 is a liquid crystal display apparatus which substantially has 1080 or more horizontal scanning lines. Hereinafter, description will be made by setting the image display section 17 as a liquid crystal display apparatus. According to the other embodiments, however, the image display section 17 may be a plasma display apparatus or a cathode ray tube (CRT).

The CPU 14 is in charge of overall control of the sections which constitute the television receiver 11. The CPU 14 executes control corresponding to operation information entered through an operation section (including a not-shown remote controller) 20 from a user.

A memory section 21 functions as a processing program storage memory to cause the CPU 14 to carry out a control operation, or as a work memory to store data during the execution of the control operation of the CPU 14.

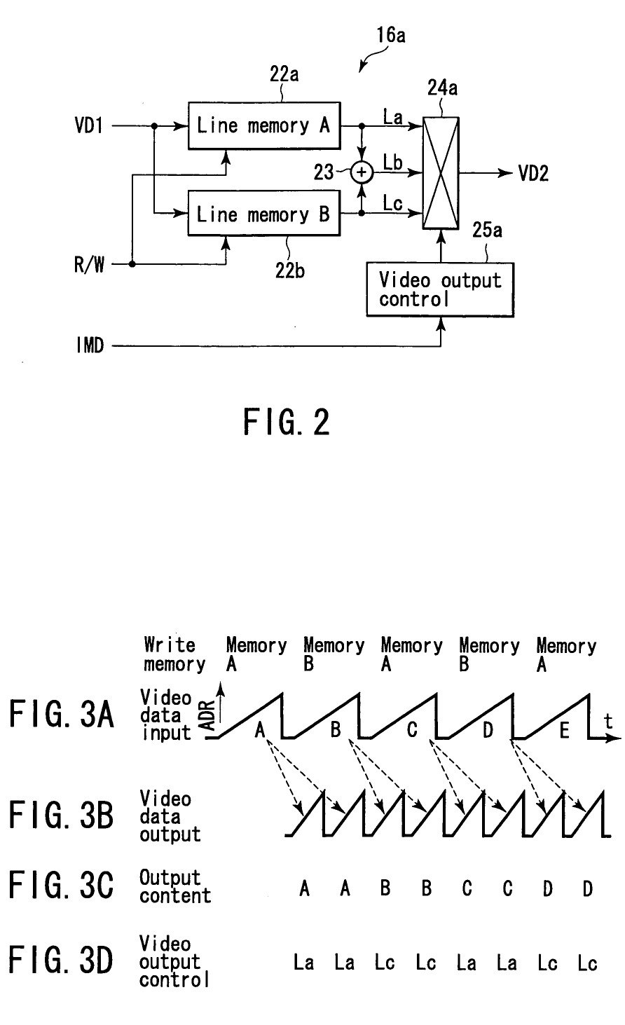

FIG. 2 is a block diagram showing a constitution of the video signal switching section 16a according to a first embodiment of the present invention.

A line memory 22a (line memory A, hereinafter) and a line memory 22b (line memory B) store video data of one scanning line. The video data VD1 is stored for every scanning line alternately in the line memories A and B. A calculator 23 synthesizes outputs of the line memories A and B at a predetermined ratio to calculate a new video signal. For example, it calculates average values of outputs of the line memories A and B.

A selector circuit 24a selects one of the outputs of the line memories A and B and the calculator 23, and outputs it as video data VD2 of a scanning line. A video output control section 25a controls the selector circuit 24a in accordance with the system discrimination signal IMD.

FIGS. 3A to 3D are timing charts showing an operation of the video signal switching section 16a when the input signal system is an interlace system, e.g., 480i, 1080i or the like.

For example, when the input signal system is 1080i, video data of 540 scanning lines are entered as video data to the television receiver 11. As shown in FIG. 3A, at the video signal switching section 16a, the video data are written for every scanning line alternately in the line memories A and B. In each of FIGS. 3A and 3B, an ordinate represents a memory address (ADR), and an abscissa represents time (t). The video data written in the line memories A and B are read twice at a speed which is double of that during writing of FIG. 3A as shown in FIG. 3B.

FIG. 3D shows a control output of a video output control section 25a. That is, the video output control section 25a controls the selector 24a so that an output line La of the line memory A can be selected near a time zone where the video data is written in the line memory B. Additionally, the video output control section 25a controls the selector 24a so that an output line Lc of the line memory B can be selected near a time zone where the video data is written in the line memory A.

As a result, as shown in FIG. 3C, the data which has been written in the line memory A is outputted twice from the selector 24a near the time zone where the video data is written in the line memory B. Near the time zone where the video data is written in the line memory A, the data which has been written in the line memory B is outputted twice.

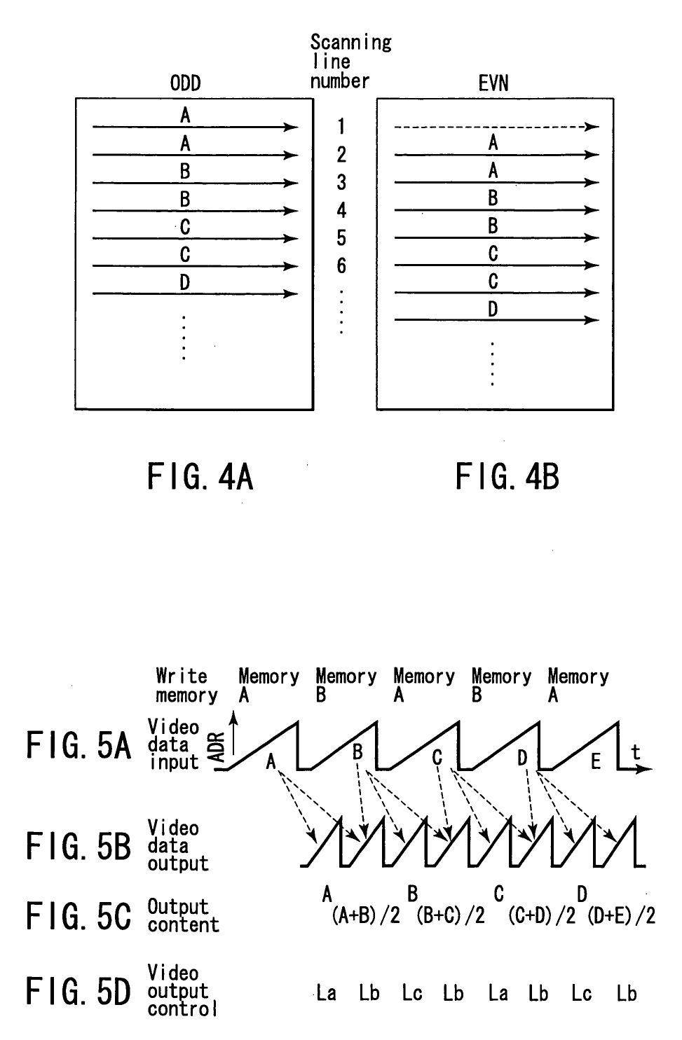

FIGS. 4A and 4B display a display sequence of video data in odd (ODD) and even (EVN) fields when the video outputted for the circuit of FIG. 2 is displayed. As shown in FIG. 4A, in the odd field, video signals of a scanning line are displayed in a sequence of A, A, B, B, C, C, D, . . . from the first scanning line of the display apparatus 17. In the even field, video data of a scanning line are displayed in a sequence of A, A, B, B, C, C, D, . . . from the second scanning line of the display apparatus 17. Thus, in the odd and even fields, the video data are displayed on the display apparatus 17 by being shifted by a predetermined number of reading times×(½) scanning lines. According to the embodiment, the video data of the same scanning line is scanned (displayed) by n times, and a scanning line position is shifted by n/2 in the next field, and thus the video data of the same scanning line is similarly scanned (displayed) by n times. Therefore, highly precise video representation is possible.

As described above, the interlaced signal can be displayed on the progressive scanning display apparatus in a pseudo progressive scanning manner. This video can be displayed with fewer blurs of a vertical direction and higher resolution compared with the conventional system which displays an average value of the input video data of the upper and lower interlace scanning lines adjacent to each other through one scanning line as video data of the middle scanning line. In the case of this display system, interlacing flickers are less conspicuous in the display apparatus of a greater number of scanning lines and higher vertical resolution, and good displaying can be carried out without using any field memories. Especially, the present invention is effective in the progressive scanning display apparatus such as a liquid or plasma display apparatus which has 1080 or more effective scanning lines.

Description now will be made of an operation when not an interlaced but progressive scan video signal is entered, and its video is expanded and displayed.

FIGS. 5A to 5D are timing charts showing an operation of the video signal switching section 16a when an input signal system is a progressive scan system such as 480p or 720p. According to this system, the average value of the video data of the upper and lower scanning lines adjacent to each other through one scanning line is displayed as video data of the middle scanning line.

For example, in the case of the input signal system of 480p, video data of 480 scanning lines are entered as video data of one frame to the television receiver 11. As shown in FIG. 5A, at the video signal switching section 16a, the video data are written for every scanning line alternately in the line memories A and B. As shown in FIG. 5B, the video data written in the line memories A and B are read three times at a speed higher by two times than that during writing of FIG. 5A.

FIG. 5D shows a control output of the video output control section 25a. That is, the video output control section 25a controls the selector 24a so that output lines can be selected in order of La, Lb near the time zone where the video data is written in the line memory B. The video output control section 25a controls the selector 24a so that output lines can be selected in order of Lc, Lb near the time zone where the video data is written in the line memory A.

As a result, as shown in FIG. 5C, an average value (e.g., (A+B)/2) of video data of two scanning lines adjacent to each other through one scanning line is outputted from the selector 24a as video date of a middle scanning line. In the case of the input signal system of 720p, newly calculated video data is outputted to one of three scanning lines of the display apparatus 17.

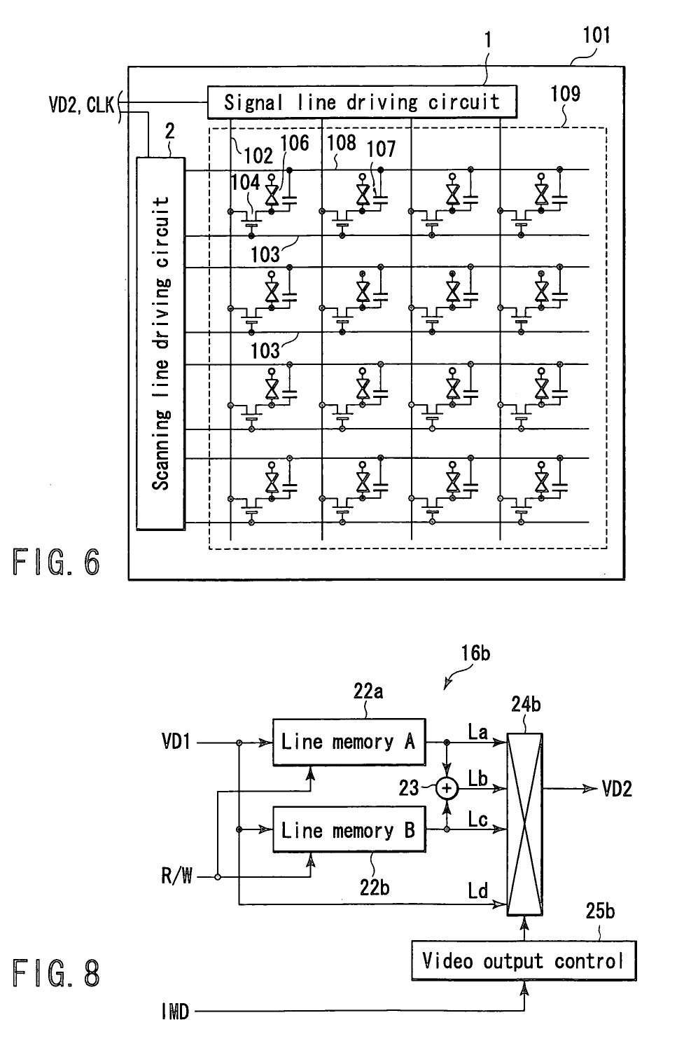

The image display apparatus 17 will now be described. FIG. 6 shows as constitutional example of a liquid crystal display apparatus as the image display apparatus 17.

In this display apparatus, display pixels each of which comprises a thin film transistor device (referred to as TFT, hereinafter) 104, a liquid crystal capacitor element 106 connected to a source of the TFT 104, and an auxiliary capacitor (Cs) 107 are arranged in a matrix on a glass substrate 101. A reference numeral 109 denotes a display area constituted of the display pixels. Each signal line 102 is connected to drains of the TFTs 104 which constitute each column, and each scanning line 103 is connected to gates of the TFTs 104 which constitute each row. Each Cs line 108 is wired to the other terminals of the auxiliary capacitor 107 of each row.

A signal line driving circuit 1 receives a pixel clock signal and an X start pulse synchronized with a horizontal synchronizing signal as display control signals CLK from the display control section 18, and video data VD2 from the video signal switching section 16a, subjects the video data to D/A conversion, and sequentially supplies video signals to a plurality of signal lines 102. A scanning line driving circuit 2 receives a Y start pulse synchronized with a vertical synchronizing pulse and a horizontal synchronizing pulse as display control signals CLK from the display control section 18, and sequentially supplies scanning pulses to the scanning lines 103 at a scanning cycle.

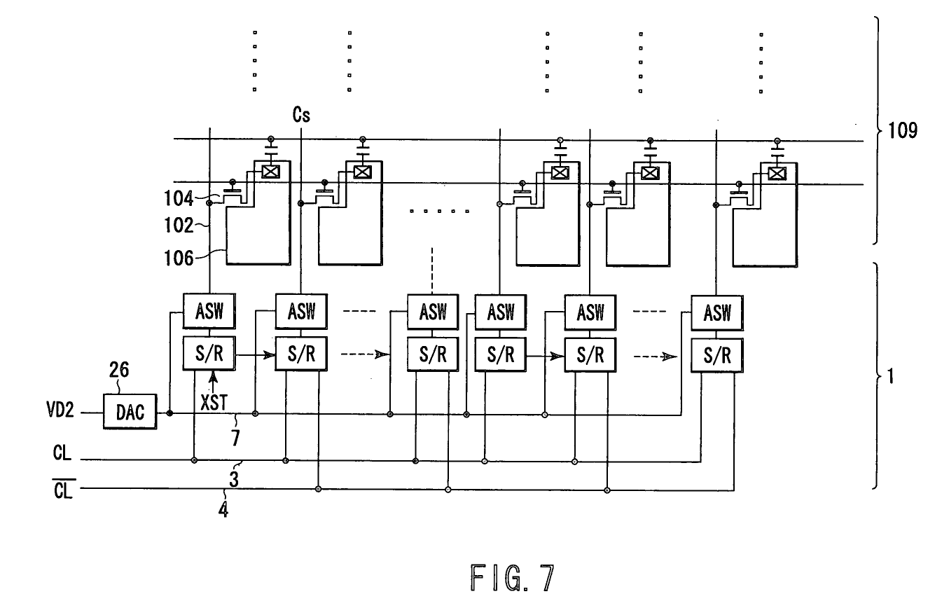

FIG. 7 is a view showing a constitutional example of the signal line driving circuit 1. In this signal line driving circuit 1, shift registers S/R are controlled by a clock signal CL synchronized with a pixel clock and a clock signal/CL obtained by reversing a clock signal, and a video signal converted into an analog signal by a DAC26 is supplied sequentially from left to right, or from right to left to the signal lines 102 at a pixel cycle by an analog switches ASW under control of the shift registers S/R.

A second embodiment of the present invention will be described. FIG. 8 is a block diagram showing a constitution of a video signal switching section 16b according to the second embodiment.

The video signal switching section 16b is operated similarly to that of FIGS. 5A to 5D when input video data VD1 is based on a progressive scan system and the video is expanded and displayed. That is, a video output control section 25b controls a selector 24b so that output lines can be selected in order of La, Lb near a time zone where the video data is written in a line memory B. The video output control section 25b controls the selector 24b so that output lines can be selected in order of Lc, Lb near a time zone where the video data is written in a line memory A.

When the input video data VD1 is based on an interlace system, the video signal switching section 16b provides the input video data VD1 directly as output video data VD2. That is, the video output control section 25b controls a selector 24b so that only a signal line Ld can be selected, and video data on the signal line Ld can be outputted as video data VD2.

Description will be made of an operation of a liquid crystal display apparatus 17 when the input video data VD1 is based on the interlace system. In this case, a scanning line driving circuit 2 (see FIG. 6) simultaneously selects (sets high levels) two adjacent scanning lines under control of a display control section 18 during one scanning period. As a result, a video signal transferred to a signal line driving circuit 1 is written in a display pixel connected to two scanning lines. That is, the scanning line driving circuit 2 sequentially supplies scanning line driving signals for every two scanning lines to a plurality of scanning lines 103. In this case, a display sequence of the video data is similar to that of the video data of FIGS. 4A and 4B displayed on the operation result display section of the video signal switching section 16a shown in FIG. 3.

A third embodiment of the present invention will now be described.

The video signal switching process described above with reference to the first and second embodiments may be changed in accordance with user instruction entered through an operation section 20. In this case, the user instructs a display mode corresponding to one of the operations of FIGS. 3A to 3D and FIGS. 5A to 5D to the television receiver 11 from the operation section 20. There are two display modes. One is a mode on which the same image signal is displayed on the two scanning lines of the display apparatus 17 as shown in FIGS. 4A and 4B, and the other is a mode on which an average value of video data of upper and lower scanning lines adjacent through one scanning line is displayed as video data of a middle scanning line as shown in FIGS. 5A to 5D.

A CPU 14 changes a control signal IMD, DMD or the like in accordance with user instruction. As a result, a video output control section 25 controls a selector circuit 24 in accordance with the user instruction, and a display control section 18 outputs a control signal CLK to a display section 17 in accordance with the user instruction. Thus, irrespective of an input video signal system, a video can be displayed on an image display section 17 on a video mode suited to user's taste. Moreover, according to the embodiment, even when an input video signal is based on an interlace system, it is possible to display an average value of video data of upper and lower scanning lines adjacent through one scanning line as video data of a middle scanning line as shown in FIGS. 5A to 5D.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An image display apparatus comprising:
first and second line memories which alternately store input video signals for every scanning line;
a reading section which reads the video signals stored in the first and second line memories at a predetermined speed;
a calculation section which calculates new video signals from the video signals read from the first and second line memories by the reading section;
a selection section which selectively outputs video signals of one scanning line among the video signals read from the first and second line memories and the new video signals calculated by the calculation section;
a video output control section which controls the selection section to select and output the video signals read from the first and second line memories when the input video signals are based on an interlace system, and to select and output the signals read from the first and second line memories and the new video signals calculated by the calculation section when the input video signals are based on a progressive scan system;
a display section which displays a video corresponding to the video signals selected by the selection section in accordance with the progressive scan system; and
a display control section which controls the display section so that odd and even fields of the video signals selected by the selection section can be displayed by being deviated from each other by a predetermined number of scanning lines.

2. The image display apparatus according to claim 1, wherein the display section is a liquid crystal display apparatus which has 1080 or more effective scanning lines.

3. The image display apparatus according to claim 1, wherein the display section is a plasma display apparatus which has 1080 or more effective scanning lines.

4. An image display apparatus comprising:
first and second line memories which alternately store input video signals for every scanning line;
a reading section which reads the video signals stored in the first and second line memories at a predetermined speed;
a calculation section which calculates new video signals from the video signals read from the first and second line memories by the reading section;
a selection section which selectively outputs video signals of one scanning line among the video signals read from the first and second line memories, the new video signals calculated by the calculation section, and the input video signals;
a video output control section which controls the selection section to select and output the input video signals when the input video signals are based on an interlace system, and to select and output the signals read from the first and second line memories and the new video signals calculated by the calculation section when the input video signals are based on a progressive scan system;
a display section which displays a video corresponding to the video signal selected by the selection section; and
a display control section which controls the display section so that odd and even fields of the video signal selected by the selection section can be displayed by being deviated from each other by one scanning line or more, and that the video signals of each scanning line selected by the selection section can be displayed on a plurality of scanning lines of the display section simultaneously in accordance with the number of one-frame scanning lines of the input video signals when the input video signals are based on the interlace system.

5. The image display apparatus according to claim 4, wherein the display section is a liquid crystal display apparatus which has 1080 or more effective scanning lines.

6. The image display apparatus according to claim 4, wherein the display section is a plasma display apparatus which has 1080 or more effective scanning lines.

7. An image display apparatus comprising:
an input terminal to which selected input video signals are supplied;
first and second line memories which alternately store the input video signals supplied to the input terminal for every scanning line;
a reading section which reads the video signals stored in the first and second line memories at a speed higher by n times (n is an integer of 2 or higher) than that during storing;
a calculation section which sequentially adds first and second video signals read from the first and second line memories at a predetermined ratio to calculate third video signals;
a selection section to which the first, second and third video signals are entered, and which selectively outputs one of the video signals in accordance with a type of the input video signal;
a video output control section which controls the selection section to alternately select and output the video signals read from the first and second line memories by n times when the input video signals are based on an interlace system, and to alternately select the first and second video signals and to arrange the third video signal therebetween when the input video signals are based on a progressive scan system;
a display section which displays a video corresponding to the video signals selected by the selection section in accordance with the progressive scan system; and
a display control section which controls the display section so that odd and even fields of the video signals selected by the selection section can be displayed with the fields deviated from each other by n/2 scanning lines.

8. A scanning line converting and displaying method comprising:
alternately storing input video signals in first and second line memories for every scanning line;
reading the video signals stored in the first and second line memories at a predetermined speed;
adding the video signals read from the first memory and the video signals read from the second line memory to generate a new video signal;
sequentially selecting and outputting the video signals read from the first and second line memories when the input video signals are based on an interlace system, and sequentially selecting and outputting the video signals read from the first and second line memories and the new video signals when the input video signals are based on a progressive scan system; and
controlling a display apparatus so that odd and even fields of the video signals can be displayed with the fields deviated from each other by a predetermined number of scanning lines.
